(19) United States
(12) Patent Application Publication
(10) Pub. No.: US 2022/0205863 A1
(43) Pub. Date: Jun. 30, 2022

(54) APPARATUS, SYSTEM, AND METHOD FOR HYDROSTATIC PRESSURE TESTING OF A PIPE

(71) Applicant: G.R.P. Mechanical Company, Inc., Bethalto, IL (US)

(72) Inventor: Mark Wayne Wadlow, Bethalto, IL (US)

(21) Appl. No.: 17/247,944

(22) Filed: Dec. 31, 2020

(51) Int. Cl. G01M 3/28; G01M 3/02

(52) U.S. Cl. CPC G01M 3/2815; G01M 3/022

(57) ABSTRACT

An apparatus includes a blind flange and a clamp configured to clamp the blind flange to a pipe flange in sealing engagement. The clamp includes a body and a latch. The body is configured to extend around the blind flange and the pipe flange and includes a first portion and a second portion movable with respect to the first portion. The latch is configured to secure the body on the blind flange and the pipe flange. The clamp also includes a plurality of wedges spaced circumferentially about the body and rotatably connected thereto. The latch is selectively adjustable to move the first portion of the clamp body towards the second portion of the clamp body such that the plurality of wedges engage respective outer surfaces of the blind flange and the pipe flange to press the blind flange against the pipe flange.

### BACKGROUND

The present disclosure relates generally to pipe systems and, more particularly, to apparatus, system, and method for hydrostatic pressure testing of a pipe.

Pipe systems are commonly used to transport fluids, which are sometimes potentially hazardous. Accordingly, the pipe systems need to be regularly tested to ensure reliability and prevent fluid leakage or failure of the pipe systems when transporting the fluids. For example, the pipe systems may be subjected to hydrostatic pressure testing in which the pipe is sealed and a pressurized fluid is injected into the interior cavity of a pipe to test for leaks and ensure that the pipe can handle desired pressures. Typically, one or more plates are attached to a flange of the pipe by bolts or other fasteners to seal the pipe for hydrostatic pressure testing. However, existing methods for sealing a pipe for hydrostatic pressure testing can be difficult and time consuming. In some existing systems and methods, for example, a plate is precisely aligned and pressed against a pipe flange while bolts are tightened in specific patterns (e.g., cross or star patterns) to ensure a proper seal of the plate against the pipe flange. Sometimes, it can take several hours or days to properly seal a pipe system for hydrostatic pressure testing.

Therefore, there is a need for an apparatus for sealing a pipe flange for hydrostatic pressure testing that provides a tight seal and requires less time and training to install.

### BRIEF DESCRIPTION

In one aspect, an apparatus includes a blind flange configured for sealing engagement with a pipe flange. The apparatus also includes a clamp configured to clamp the blind flange to the pipe flange in sealing engagement. The clamp includes a body and a latch. The body is configured to extend around the blind flange and the pipe flange and includes a first portion and a second portion movable with respect to the first portion. The latch is configured to secure the body on the blind flange and the pipe flange. The clamp also includes a plurality of wedges spaced circumferentially about the body and rotatably connected thereto. The latch is selectively adjustable to move the first portion of the clamp body towards the second portion of the clamp body such that the plurality of wedges engage respective outer surfaces of the blind flange and the pipe flange to press the blind flange against the pipe flange.

In another aspect, a system includes a pressurization device connected in fluid communication with an interior space of the pipe. The pressurization device is configured to regulate a pressure within the interior space of the pipe. The system also includes an apparatus configured to attach to a pipe flange. The apparatus includes a blind flange configured for sealing engagement with the pipe flange. The apparatus also includes a clamp configured to clamp the blind flange to the pipe flange in sealing engagement. The clamp includes a body and a latch. The body is configured to extend around the blind flange and the pipe flange. The body includes a first portion and a second portion movable with respect to the first portion. The latch is configured to secure the body on the blind flange and the pipe flange. The clamp also includes a plurality of wedges spaced circumferentially about the body and rotatably connected thereto. The latch is selectively adjustable to move the first portion of the clamp body towards the second portion of the clamp body such that the plurality of wedges engage respective outer surfaces of the blind flange and pipe flange to press the blind flange against the pipe flange.

In yet another embodiment, a method for hydrostatic pressure testing of a pipe includes connecting a pressurization device in fluid communication with an interior space of the pipe. The method also includes positioning a blind flange for sealing engagement with a pipe flange of the pipe, and positioning a body of a clamp around the blind flange and the pipe flange. The body includes a first portion and a second portion movable with respect to the first portion, and the clamp includes a latch and a plurality of wedges spaced circumferentially about the body. The method further includes moving the first portion of the clamp body towards the second portion of the clamp body by selectively adjusting the latch such that the plurality of wedges engage respective outer surfaces of the blind flange and pipe flange to press the blind flange against the pipe flange. The method further includes raising a pressure within the interior space of the pipe using the pressurization device.

These and other features, aspects and advantages of the present disclosure will become better understood with reference to the following description and appended claims. The accompanying drawings, which are incorporated in and constitute a part of this specification, illustrate embodiments of the disclosure and, together with the description, serve to explain the principles of the disclosure.

### BRIEF DESCRIPTION OF THE DRAWINGS

FIG. 1 is a schematic diagram of a system for hydrostatic pressure testing of a pipe;

FIG. 2 is a sectional view of a portion of the system shown in FIG. 1, taken along line 2-2 in FIG. 1, and showing an apparatus for sealing a pipe flange;

FIG. 3 is bottom view of a blind flange of the apparatus shown in FIG. 2;

FIG. 4 is a front view of a clamp of the apparatus shown in FIG. 2;

FIG. 5 is a perspective view of the clamp shown in FIG. 4, illustrating a latch of the clamp;

FIG. 6 is a perspective view of the clamp shown in FIG. 4 in an opened position;

FIG. 7 is a perspective view of a first portion of the clamp shown in FIG. 4;

FIG. 8 is an enlarged perspective view of a portion of the clamp shown in FIG. 4, illustrating a wedge of the clamp;

FIG. 9 is a side view of the wedge shown in FIG. 8;

FIG. 10 is a perspective view of a portion of another apparatus for use with the system shown in FIG. 1, illustrating wedge alignment features; and

FIG. 11 is a flow diagram of an exemplary method for hydrostatic pressure testing of a pipe.

Corresponding reference characters indicate corresponding parts throughout the several views of the drawings.

### DETAILED DESCRIPTION

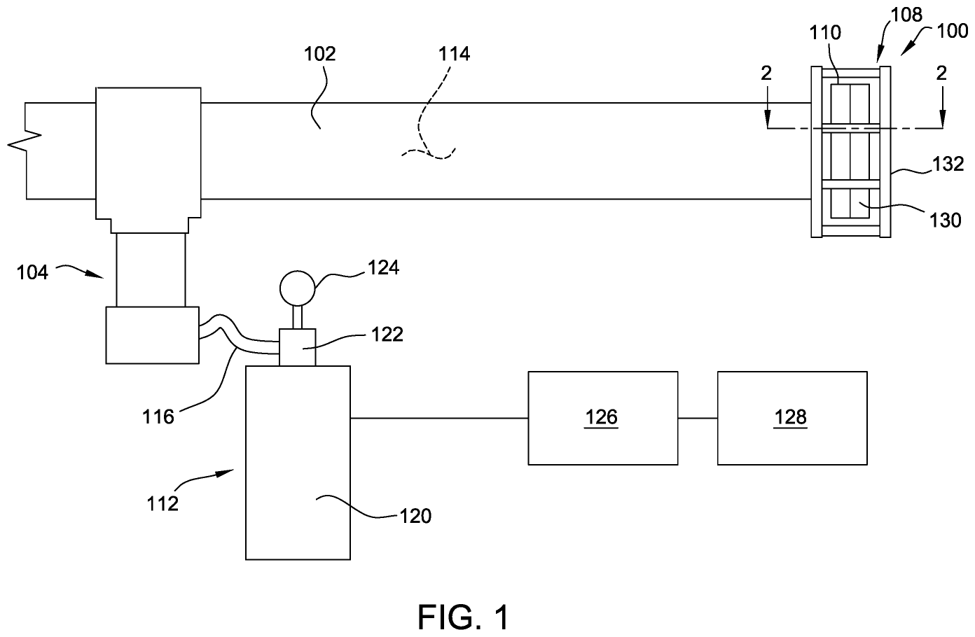

FIG. 1 is a schematic diagram of an example system 100 for hydrostatic pressure testing of a pipe 102. The system 100 includes an apparatus 108 configured for sealing engagement with a pipe flange 110, and a pressurization device 112.

The pressurization device 112 is connected in fluid communication with an interior space 114 of the pipe 102. The pressurization device 112 may be connected to the interior space via a pipe fitting, a pipe, an inlet/outlet, a cleanout, and/or any other apparatus connected to the pipe 102. For example, the pressurization device 112 includes a conduit 116 that is connected to the pipe 102 via a second pipe 104.

The pressurization device 112 is configured to regulate a pressure within the interior space 114 of the pipe 102. For example, the pressurization device 112 includes a pressurized fluid source 120, at least one valve 122, and a gauge 124. The pressurization device 112 is configured to deliver pressurized fluid to the interior space 114 to provide a desired pressure within the interior space 114 and to monitor the pressure within interior space 114. The pressurized fluid can include, for example and without limitation, pressurized air (pneumatic) or water (hydro). In some embodiments, the pressurization device 112 may include one or more sensors coupled to the conduit 116, the pipe 102, and/or the pipe 104. The sensors can detect at least one characteristic of fluid within the pressurization device 112 and/or the pipe 102, such as the pressure.

The pressurization device 112 may include a controller 126 that communicates with one or more components of the system 100. The controller 126 includes a memory device and a processor to store and execute computer-executable instructions to control components of the system 100. In some embodiments, the processor includes one or more processing units (e.g., in a multi-core configuration). The memory device may be any device that allows information such as executable instructions and/or other data to be stored and retrieved. Specifically, in some embodiments, the controller 126 includes, for example and without limitation, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM).

The controller 126 is configured to control operation of the pressurization device 112 and determine diagnostic information based on information during the hydrostatic pressure testing of the pipe 102. For example, the pressurization device 112 may be configured to identify leaks in the pipe 102 based on pressure readings and/or other parameters during the hydrostatic pressure test.

The controller 126 includes or is coupled to a user interface 128 configured to receive input from and/or provide output to a user. In some embodiments, the user interface 128 includes one or more input devices, such as for example, a keyboard, a pointing device, a mouse, a stylus, a touch sensitive panel (e.g., a touch pad or a touch screen), a camera, a position detector, and/or an audio input device. In some embodiments, the user interface 128 includes one or more output devices, such as a display device (e.g., a liquid crystal display (LCD), organic light emitting diode (OLED) display, cathode ray tube (CRT), or “electronic ink” display) or an audio output device (e.g., a speaker or headphones). In some embodiments a single component such as a touch screen functions as both an output device and an input device of the user interface 128. For example, the user interface 128 may display information for the user based on parameters of the hydrostatic pressure test and/or receive user inputs relating to parameters of the hydrostatic pressure test.

In some embodiments, the controller 126 is coupled to one or more components via a wired and/or a wireless connection. The controller may include a communication interface, which is communicatively couplable to any component of the system 100. In some embodiments, the communication interface includes, for example, a wired or wireless network adapter or a wireless data transceiver for use with a local area network (LAN) or a wide area network (WAN), dial-in-connections, cable modems, special high-speed Integrated Services Digital Network (ISDN) lines, RDT networks, and/or a mobile phone network (e.g., Global System for Mobile communications (GSM), 3G, 4G or Bluetooth) or other mobile data network (e.g., Worldwide Interoperability for Microwave Access (WIMAX)).

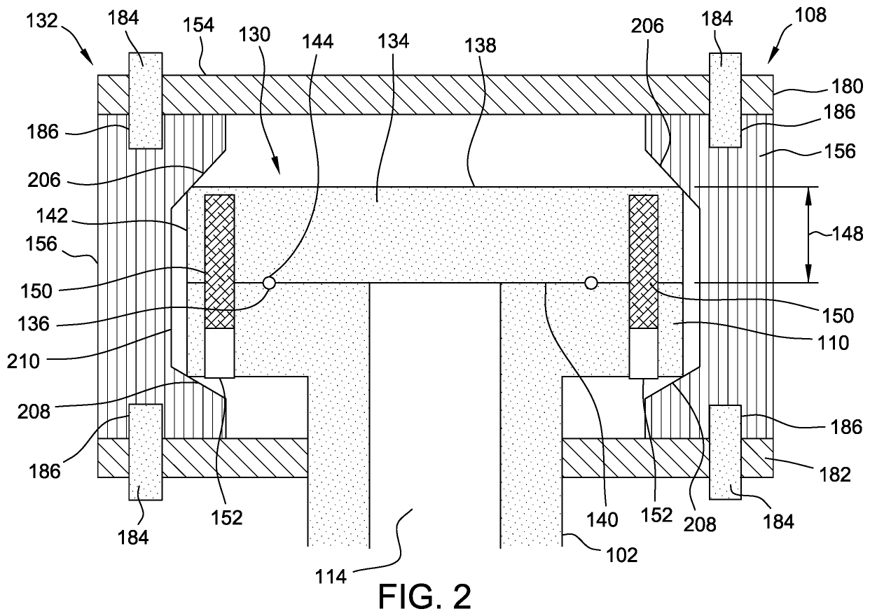

As illustrated in FIG. 2, the apparatus 108 includes a blind flange 130 and a clamp 132. The blind flange 130 is configured to sealingly engage the pipe flange 110. For example, the blind flange 130 may include a plate 134 and a seal 136 that sealingly engages the pipe flange 110. The seal 136 can include any suitable sealing material that enables the apparatus 108 to function as described herein, such as a compressible elastic material. For example, in some embodiments, the seal 136 can include, for example and without limitation, an O-ring, gasket, or other suitable seal. The clamp 132 is configured to press or force the plate 134 towards the pipe flange 110 such that the seal 136 engages the pipe flange 110 and prevents fluid from flowing into or out of the interior space 114.

The plate 134 includes a first, outward-facing surface 138, a second, sealing surface 140, and a radial outer circumferential surface or edge 142. The first surface 138 and the outer circumferential edge 142 are collectively referred to as an outer surface of the plate 134. The outer edge 142 extends circumferentially about and between the first surface 138 and the second surface 140. The first surface 138 is substantially flat or planar. The second surface 140 is substantially flat or planar, and includes a groove 144 defined therein sized and shaped to receive at least a portion of the seal 136 therein. The second surface 140 is configured to engage the pipe flange 110 when the clamp 132 presses the blind flange 130 against the pipe flange 110. The groove 144 is spaced radially inward of the outer edge 142 and is arranged such that the seal 136 is positioned between the interior space 114 of the pipe 102 and the outer edge of the pipe flange 110 when the seal 136 is positioned in the groove 144 and the apparatus 108 is attached to the pipe flange 110.

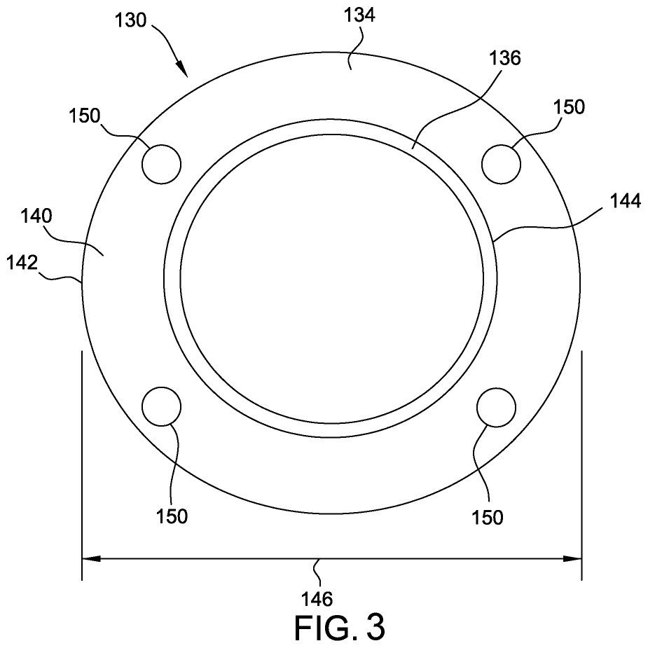

With reference to FIGS. 2 and 3, the plate 134 may be any suitable shape including, for example and without limitation, circular, rectangular, triangular, polygonal, and elliptical. In the illustrated embodiment, the plate 134 is circular. The plate 134 has a diameter or width 146 defined by the outer edge 142. In some embodiments, the diameter 146 can be in the range of 110 millimeters (mm) (4.33 inches) to 530 mm (20.87 inches), in the range of 110 mm (4.33 inches) to 485 mm (19.09 inches), or in the range of 130 mm (5.12 inches) to 530 mm (20.87 inches). In other embodiments, the diameter 146 can be less than 110 mm, or greater than 530 mm. The diameter 146 is selected such that the blind flange 130 covers or occludes an opening in the pipe flange 110 to seal the pipe flange 110. For example, in some embodiments, the diameter 146 is substantially equal to or greater than a diameter of the pipe flange 110. In further embodiments, the diameter 146 is selected to accommodate a range of sizes of pipe flanges.

The plate 134 has a thickness 148 defined between the first surface 138 and the second surface 140. In some embodiments, the thickness 148 can be in the range of 15 mm (0.59 inches) to 51 mm (2.0 inches), in the range of 15 mm (0.59 inches) to 32 mm (1.26 inches), or in the range of 19 mm (0.75 inches) to 51 mm (2.0 inches). In other embodiments, the thickness 148 can be less than 15 mm, or greater than 51 mm. The thickness 148 is selected based on the class of pipe for which the plate 134 is intended for use (e.g., class 150 or class 300), and such that the plate 134 is substantially rigid and resists warping or bending during hydrostatic pressure tests. As described further herein, the apparatus 108 is designed to accommodate the thickness 148 of the plate 134 and the thickness of the pipe flange 110.

The plate 134 may be constructed of any suitable materials. In the example embodiment, the plate 134 is a unitary or integral piece and is constructed from metal (e.g., a solid metal plate). The plate 134 is constructed to withstand relatively high pressures experienced during hydrostatic pressure tests and prevent leaks out of the pipe 102. In addition, the plate 134 may be relatively simple and inexpensive to manufacture. Moreover, the plate 134 may be modular and may be used with different apparatus.

The plate 134 may include one or more features that facilitate the clamp 132 engaging the outer surface (i.e., the first surface 138 and/or the outer circumferential edge 142) of the plate 134. For example, the plate 134 may include a fillet or chamfer extending between the outer edge 142 and the first surface 138 and/or the outer edge 142 and the second surface 140. For example, in some embodiments, the plate 134 has a fillet between the first surface 138 and the outer edge 142 and between the second surface 140 and the outer edge 142. The fillet or chamfer increases the contact area between the blind flange 130 and the clamp 132 (shown in FIG. 2) and reduces stress concentrations that could occur on a corner of the plate 134.

In addition, the blind flange 130 includes a plurality of alignment pegs 150 protruding from the plate 134 of the blind flange 130 and configured to fit into mounting openings 152 in the pipe flange (shown in FIG. 2). The alignment pegs 150 may be any suitable material and may be attached to the plate 134 in any suitable manner. In the example embodiment, the alignment pegs 150 are constructed from metal and are welded to the plate 134. The alignment pegs 150 are positioned about the circumference of the plate 134 between the groove 144 and the outer edge 142. The alignment pegs 150 are arranged in a pattern that corresponds to the openings 152 in the pipe flange 110. In addition, the alignment pegs 150 have a diameter that is substantially equal to the diameter of the openings 152 in the pipe flange 110. Accordingly, the alignment pegs 150 provide a tight fit within the mount openings 152 and prevent shifting of the blind flange 130. In some embodiments, the diameter of each alignment peg 150 is in the range of 15 mm (0.59 inches) to 32 mm (1.26 inches), in the range of 15 mm (0.59 inches) to 26 mm (1.02 inches), or in the range of 19 mm (0.75 inches) to 32 mm (1.26 inches). In other embodiments, the diameter of each alignment peg 150 can be less than 15 mm, or greater than 32 mm.

To assemble the blind flange 130 on the pipe flange 110, the alignment pegs 150 are inserted into the openings 152 in the pipe flange 110 to align the blind flange 130 on the pipe flange 110. As a result, the blind flange 130 is simpler and quicker to position on the pipe flange 110 than other apparatus. For example, the alignment pegs 150 provide an “automatic” alignment of the blind flange 130 on the pipe flange 110 when the alignment pegs 150 are positioned in the openings 152. In addition, the alignment pegs 150 prevent the blind flange 130 from shifting out of alignment prior to or during tightening of the clamp 132 on the blind flange 130 and the pipe flange 110, as described further herein.

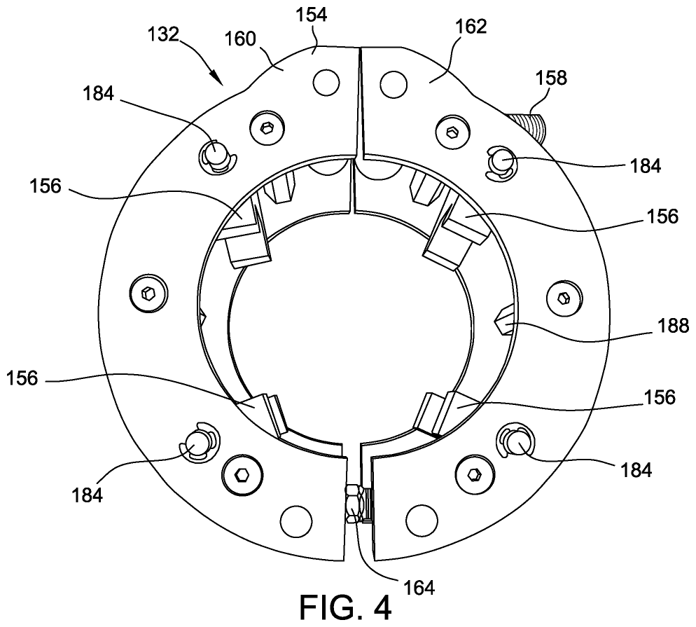

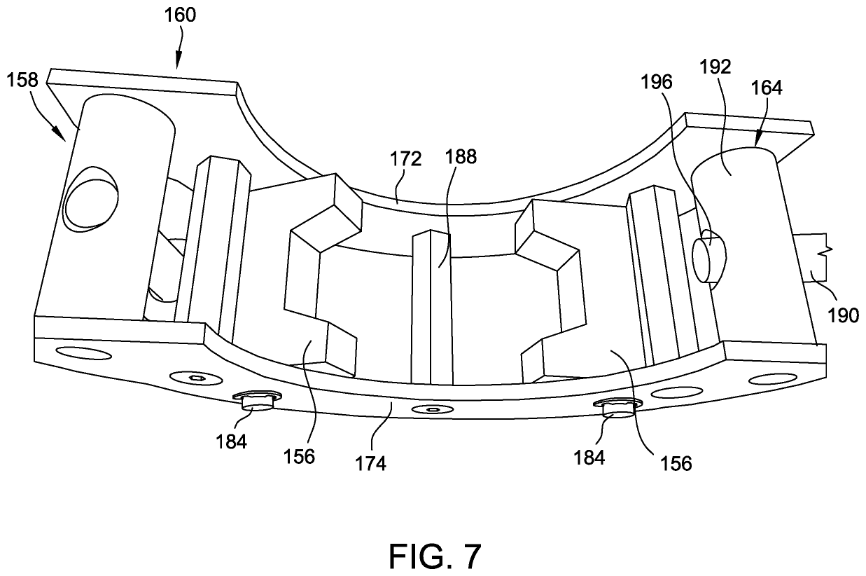

Referring to FIGS. 4-7, the clamp 132 includes a body 154, a plurality of wedges 156, and a latch 158. The body 154 fits around the blind flange 130 and the pipe flange 110 such that the plurality of wedges 156 engage the outer surface (i.e., the first surface 138 and/or the outer circumferential edge 142) of the blind flange 130 and press the blind flange 130 against the pipe flange 110 when the clamp 132 is tightened on the blind flange 130 and the pipe flange 110 using the latch 158.

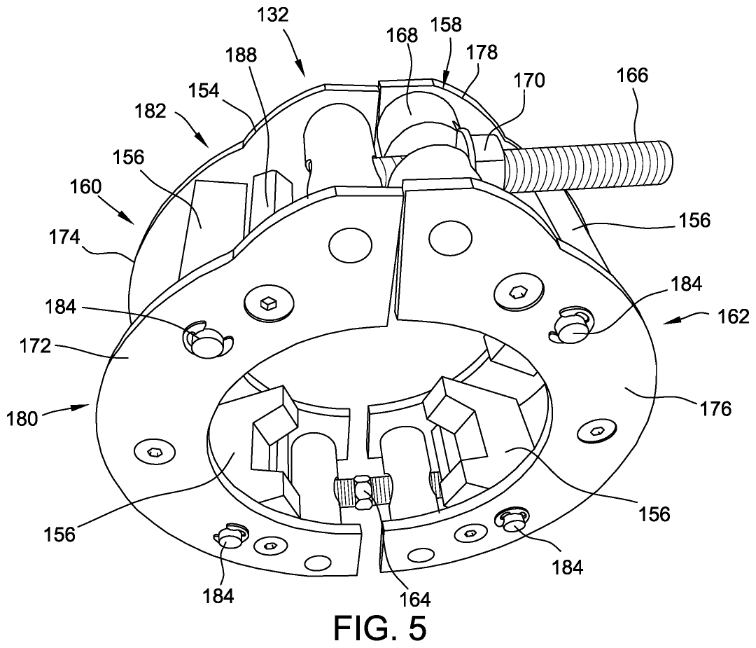

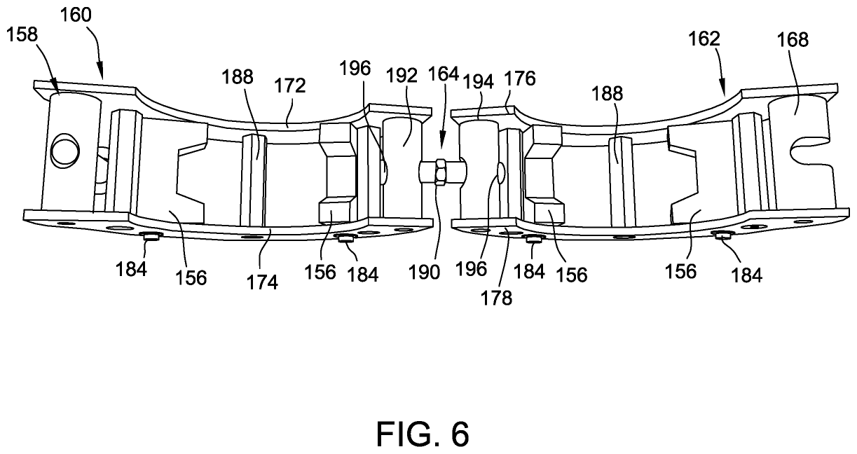

The body 154 includes a first portion 160 and a second portion 162 that is pivotably connected to the first portion 160 by a hinge 164. The body 154 is configurable between an open position (FIG. 6), in which the first portion 160 and the second portion 162 are configured to receive the blind flange 130 and the pipe flange 110 therebetween, and a closed position (FIGS. 4 and 5), in which the body 154 is configured to completely encircle the blind flange 130 and the pipe flange 110.

The latch 158 is configured to connect the first portion 160 to the second portion 162 and lock the first portion 160 and the second portion 162 in the closed position. In the illustrated embodiment, the latch 158 includes a threaded rod 166, a receiver 168, and a nut 170. In the example embodiment, the threaded rod 166 is rotatably connected to the first portion 160 by a pin (not labeled), and the receiver 168 is mounted to the second portion 162. The nut 170 is threadably connected to the threaded rod 166, and the position of the nut 170 is selectively adjustable along the rod 166 by rotating the nut 170 relative to the rod 166. The receiver 168 is configured to receive the threaded rod 166 and nut 170 to secure the first portion 160 and the second portion 162 together in the closed configuration. The threaded rod 166 and/or the receiver 168 may be positionable relative to the body 154 of the clamp 132 to facilitate the threaded rod 166 and nut 170 engaging the receiver 168.

The latch 158 is configured to tighten the clamp 132 about the blind flange 130 and the pipe flange 110 when the threaded rod 166 is secured in the receiver 168. For example, the nut 170 may be tightened on the threaded rod 166 to engage the receiver 168 when the threaded rod 166 is positioned in the receiver. As the nut 170 is tightened against the receiver 168, the second portion 162 is forced towards the first portion 160, which in turn causes the wedges 156 to engage the pipe flange 110 and the blind flange 130, pressing the pipe flange 110 and the blind flange 130 together to form a seal therebetween. The nut 170 can also be loosened to permit removal of the threaded rod 166 from the receiver 168. When the threaded rod 166 is removed from the receiver 168, the clamp 132 can be positioned from the closed position to the opened position. The latch 158 facilitates the clamp 132 being quickly and easily locked in the closed position and tightened using a single latch instead of a plurality of bolts. In addition, the clamp 132 distributes pressure evenly around the circumference of the blind flange 130 and the pipe flange as the clamp 132 is tightened. In alternative embodiments, the latch 158 may include clips, pins, sockets, or any other suitable securement mechanisms that enable the apparatus 108 to function as described herein.

The first portion 160 of the clamp 132 includes a first plate 172 and a second plate 174 spaced axially apart. The second portion 162 of the clamp 132 includes a first plate 176 and a second plate 178 spaced axially apart. In the illustrated embodiment, the first and second plates 172, 174 of the first portion 160 and the first and second plates 176, 178 of the second portion 162 are each C-shaped. The first plate 172 of the first portion 160 and the first plate 176 of the second portion 162 cooperatively define a first ring 180 when the body 154 is in the closed position (as shown in FIG. 5). The second plate 174 of the first portion 160 and the second plate 178 of the second portion 162 cooperatively define a second ring 182 axially spaced from the first ring 180 (as shown in FIG. 5) when the body 154 is in the closed position.

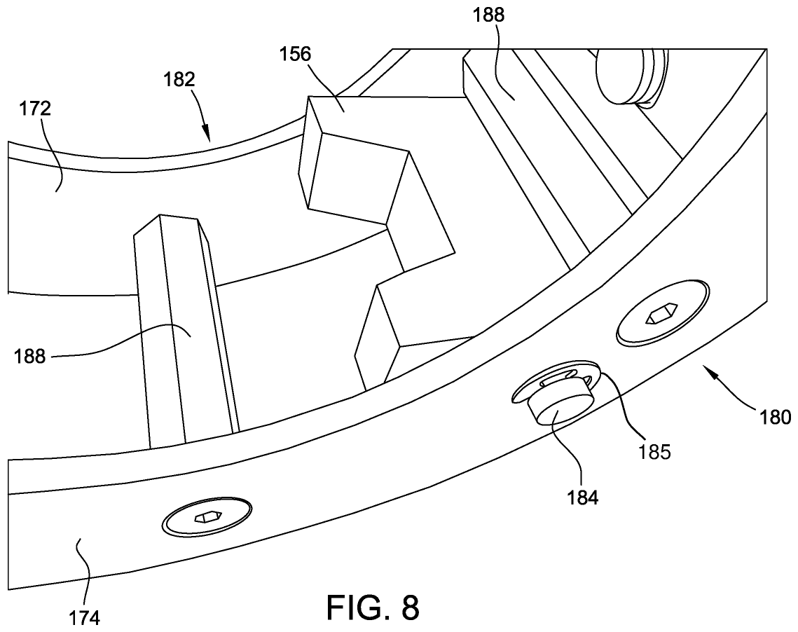

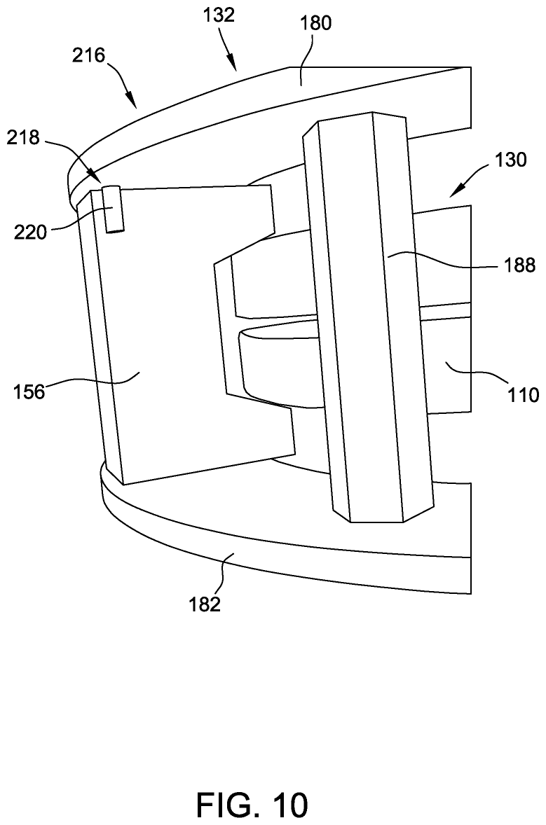

With reference to FIG. 8, the wedges 156 are rotatably coupled to and extend between the first ring 180 and the second ring 182. For example, the wedges 156 may be removably attached to the first ring 180 and the second ring 182 by pins 184 extending through the first ring 180 and the second ring 182 and into openings 186 defined in the wedges 156. The wedges 156 may pivot about the pins 184 to facilitate aligning the wedges 156 with the pipe flange 110 and the blind flange 130 (shown in FIG. 2) as the clamp 132 is tightened on the pipe flange 110 and the blind flange 130. The pins 184 can be retained in place using any suitable retainer or fastener. In the illustrated embodiment, the pins 184 are retained in place by C-shaped spring clips 185. In some embodiments, the clamp 132 may include alignment features, such as wedge alignment features 218 (shown in FIG. 10), to limit rotation of the wedges 156 and facilitate alignment of the wedges 156 with the pipe flange 110 and the blind flange 130.

The clamp 132 also includes one or more spacers 188 coupled to and extending between the first ring 180 and the second ring 182. The spacers 188 connect the first ring 180 to the second ring 182 and maintain a desired distance between the first ring 180 and the second ring 182. The spacers 188 may have a length that is greater than a length of the wedges 156. Accordingly, the spacers 188 allow clearance for the wedges 156 to pivot relative to the first ring 180 and the second ring 182. In some embodiments, the spacers 188 are omitted and the first ring 180 and the second ring 182 are held together by the wedges 156 and/or other structural members (e.g., rods, braces, brackets, etc.).

Referring again to FIG. 6, the hinge 164 of the illustrated embodiment includes a threaded rod 190, a first pivot 192, and a second pivot 194. The first pivot 192 is pivotably attached to the first plate 172 and the second plate 174 of the first portion 160 such that the first portion 160 is rotatable relative to the first pivot 192 and the second portion 162. The second pivot 194 is pivotably attached to the first plate 176 and the second plate 178 of the second portion 162 such that the second portion 162 is rotatable relative to the second pivot 194 and the first portion 160. The threaded rod 190 is threadably engaged with threaded bores 196 in the first pivot 192 and the second pivot 194. Accordingly, the hinge 164 connects the first portion 160 to the second portion 162 and facilitates relative rotation of the first portion 160 and the second portion 162 such that the clamp 132 can be positioned or moved between the opened configuration and the closed configuration. In addition, the size of the clamp 132 may be adjusted by rotating the threaded rod 190 relative to the first pivot 192 or the second pivot 194. For example, rotation of the rod 190 in a first direction can move the first portion 160 and the second portion 162 closer together, and rotation of the rod 190 in a second, opposite direction can move the first portion 160 and second portion 162 further apart. This can allow the clamp 132 to accommodate a wider range of pipe sizes as compared to a clamp with a fixed size. In alternative embodiments, the clamp 132 may include leaves, knuckles, pins, bearings, bias mechanisms, and/or any other suitable hinge devices.

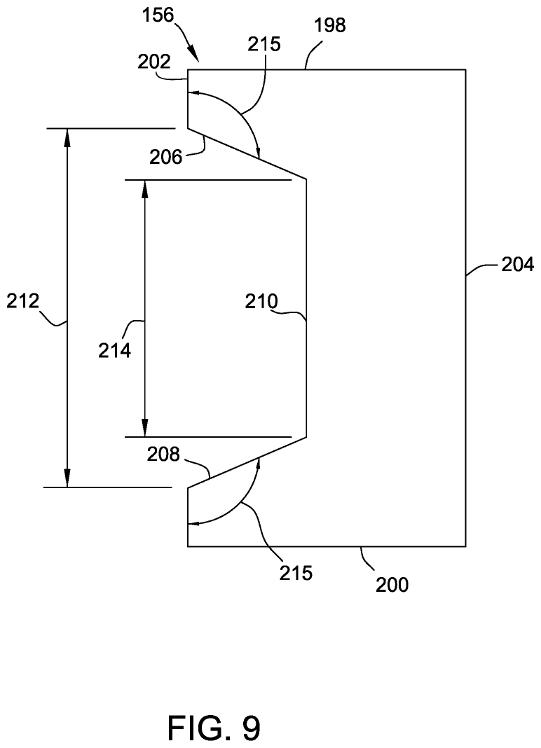

FIG. 9 is a side view of one of the wedges 156 of the clamp 132. Each wedge 156 of the clamp 132 can have an identical configuration to the wedge 156 illustrated in FIG. 9. The wedge 156 includes a first end 198, a second end 200, a first side 202, and a second side 204. The first side 202 and the second side 204 extend between the first end 198 and the second end 200. In addition, the wedge 156 includes a first ramp or angled surface 206, a second ramp or angled surface 208 opposite the first ramp 206, and a recessed surface 210 extending between the first ramp 206 and the second ramp 208. The first ramp 206 and the second ramp 208 each extend from the first side 202 to the recessed surface 210 such that the first ramp 206, the second ramp 208, and the recessed surface 210 collectively define a V- or U-shaped channel extending into the wedge 156 from the first side 202.

The first ramp 206 and the second ramp 208 are configured to engage the blind flange 130 (shown in FIG. 2) and the pipe flange 110 (shown in FIG. 2) when the clamp 132 (shown in FIG. 2) is secured around the blind flange 130 and the pipe flange 110. For example, in the arrangement shown in FIG. 2, the first ramp 206 engages the blind flange 130, and the second ramp 208 engages the pipe flange 110. The wedge 156 may be symmetric (e.g., in the illustrated embodiment, the wedge 156 is symmetric about an axis through the center of the recessed surface 210) such that the clamp 132 can be fitted onto the blind flange 130 and the pipe flange 110 in different orientations of the clamp 132.

With reference to FIGS. 2 and 9, the first ramp 206 and the second ramp 208 are sloped such that, as the clamp 132 is tightened around the blind flange 130 and the pipe flange 110 with the latch 158, the blind flange 130 and the pipe flange 110 are pressed against each other. For example, as the clamp 132 is tightened on the blind flange 130 and the pipe flange 110, the angled surfaces of the ramps 206, 208 urge or force the blind flange 130 and the pipe flange 110 closer together, compressing the seal 136 between the blind flange 130 and the pipe flange 110 and sealing off the interior space 114 of the pipe 102 (shown in FIG. 1). The wedge 156 may be sized such that a maximum distance 212 between the first ramp 206 and the second ramp 208 is greater than the cumulative thickness of the blind flange 130 and the pipe flange 110. In addition, a minimum distance 214 between the first ramp 206 and the second ramp 208 is less than the cumulative thickness of the blind flange 130 and the pipe flange 110. Accordingly, the clamp 132 may be tightened such that the blind flange 130 and the pipe flange 110 are pressed together and each is engaged along the slope of the respective ramp 206, 208.

Moreover, the first ramp 206 and the second ramp 208 are constructed to prevent slipping of the blind flange 130 or the pipe flange 110 along the respective ramp 206, 208. For example, the first ramp 206 and the second ramp 208 are oriented at an angle 215 relative to the first side 202. The angle 215 can be any suitable angle that enables that apparatus 108 to function as described herein. For example, the angle 215 can be in the range of 95° to 170°, in the range of 110° to 155°, in the range of 110° to 145°, in the range of 120° to 155°, in the range of 110° to 135°, in the range of 120° to 145°, in the range of 130° to 155°, or in the range of 125° to 145°. In some embodiments, the first ramp 206 and the second ramp 208 are each have oriented at an angle 215 of about 135° The angle 215 of the first ramp 206 and the second ramp 208 facilitates the clamp 132 pressing the blind flange 130 and the pipe flange 110 together and prevents the blind flange 130 and the pipe flange 110 from moving apart from each other when the clamp 132 is tightened.

The wedge 156 may be constructed of any suitable material. In the example embodiment, the wedge 156 is a unitary or integral piece and is constructed from metal. For example, the wedge 156 may be cut or formed from a metal material, such as steel or iron. As a result, the wedge 156 may be simple to manufacture and be configured to withstand relatively high pressures during the hydrostatic pressure test and maintain a tight fit of the blind flange 130 on the pipe flange 110.

In addition, the wedges 156 may be modular and interchangeable with other wedges to accommodate different sized pipes using the same clamp 132. For example, the wedges 156 connected to the clamp 132 can be removed (e.g., by removing spring clips 185 and, subsequently, removing pins 184), and interchanged with another set of wedges that are sized and shaped to accommodate a different sized pipe. In some embodiments, the apparatus 108 may be provided as a kit that includes multiple sets of wedges configured for use with different sized (i.e., nominal diameter) pipes. For example, the apparatus 108 may be provided with a first set of wedges (e.g., four wedges) sized and shaped for use with a first size pipe (e.g., 1.5 inch diameter pipe), a second set of wedges (e.g., four wedges) sized and shaped for use with a second size pipe (e.g., 2.0 inch diameter pipe), and a third set of wedges sized and shaped for use with a third size pipe (e.g., 3.0 inch diameter pipe). Each wedge within a given set can have a maximum distance 212, a minimum distance 214, and/or a ramp angle 215 designed to fit a particular size of pipe. For example, the wedges 156 can be sized and shaped for use with specific nominal diameter pipe sizes based on standard pipe and flange dimensions set by industry standard setting organizations, such as the American Society of Mechanical Engineers or the American National Standards Institute (e.g., ANSI B 16.5). In one particular embodiment, the apparatus 108 is provided with a first set of wedges sized and shaped for use with 1.5 inch nominal diameter class 150 pipe, a second set of wedges sized and shaped for use with 2.0 inch nominal diameter class 150 pipe, and a third set of wedges sized and shaped for use with 3.0 inch nominal diameter class 150 pipe. In another particular embodiment, the apparatus 108 is provided with a first set of wedges sized and shaped for use with 1.5 inch nominal diameter class 300 pipe, a second set of wedges sized and shaped for use with 2.0 inch nominal diameter class 300 pipe, and a third set of wedges sized and shaped for use with 3.0 inch nominal diameter class 300 pipe. The apparatus 108 may be provided with any suitable number of wedge sets that enable the apparatus 108 to function as described herein, including more than or fewer than three sets of wedges.

The apparatus 108 may also be provided with a plurality of blind flanges 130, where each one of the blind flanges 130 is configured for use with a corresponding set of wedges. For example, a first blind flange of the plurality of blind flanges can have a diameter, a thickness, and/or alignment pegs that are sized and shaped for use with the first set of wedges.

The apparatus 108, including the blind flange 130 and the wedges 156, can be configured for use with a range of different sized pipes by selecting suitable wedges 156 and blind flanges 130. In some embodiments, for example, the apparatus 108 is suitable for use with class 150 pipe and class 300 pipe having a nominal diameter in the range of 1.5 inches to 12 inches. In other embodiments, the apparatus 108 can be configured for use with classes of pipe other than 150 and 300, and pipe having a nominal diameter less than 1.5 inches or greater than 12 inches.

FIG. 10 is a perspective view of a portion of another embodiment of an apparatus 216 for use with the system 100 shown in FIG. 1. Apparatus 216 is substantially similar to the apparatus 108 shown in FIG. 2 except apparatus 216 includes wedge alignment features 218 associated with each of the wedges 156. The wedge alignment features 218 limit rotation of the associated wedge 156. For example, the wedge alignment features 218 include pins 220 attached to the clamp body 154 (e.g., to one of plates 172, 174, 176, 178). The wedge alignment features 218 are positioned adjacent sides of the wedges 156 and are configured to orient the wedges 156 to face radially inward (i.e., such that V- or U-shaped channel faces radially inward) and engage the outer surface of the blind flange 130 and the pipe flange 110 when the clamp 132 is positioned about the pipe flange 110 and the blind flange 130. The pins 220 are arranged in pairs on opposite sides of a corresponding wedge 156. Each pair of pins 220 may be spaced apart a distance that is greater than a thickness of the corresponding wedge 156 such that the wedge 156 is able to pivot a limited range between the pins 220 for engaging with the pipe flange 110 and the blind flange 130 when the clamp 132 is tightened.

In the example embodiment, the pins 220 are coupled to the first ring 180. Additionally or alternatively, the apparatus 216 may include pins 220 attached to the second ring 182. In further embodiments, the wedge alignment features 218 may include grooves in the first ring 180 and/or the second ring 182 and/or any other features that limit movement of the wedges 156. In some embodiments, the wedges 156 may be completely fixed against movement relative to the first ring 180 and the second ring 182.

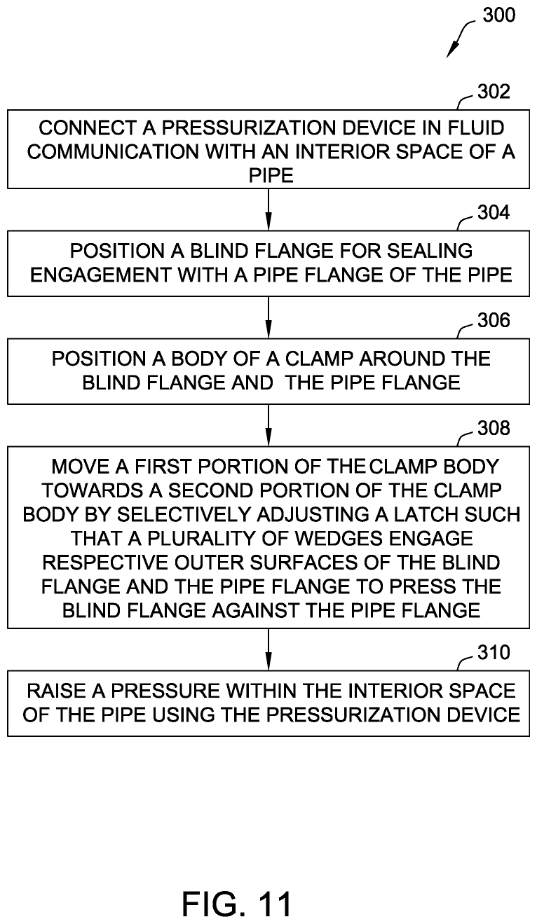

FIG. 11 is a flow diagram of an exemplary method 300 for hydrostatic pressure testing of a pipe (e.g., pipe 102 shown in FIG. 1). The method 300 includes connecting 302 a pressurization device (e.g., pressurization device 112 shown in FIG. 1) in fluid communication with an interior space (e.g., interior space 114 shown in FIG. 2) of the pipe. The method 300 also includes positioning 304 a blind flange (e.g., blind flange 130 shown in FIG. 2) for sealing engagement with a pipe flange of the pipe (e.g., pipe flange 110 shown in FIG. 2), and positioning 306 a body (e.g., body 154 shown in FIG. 2) of a clamp (e.g., clamp 132 shown in FIG. 2) around the blind flange and the pipe flange. The body includes a first portion and a second portion movable with respect to the first portion, and the clamp includes a latch and a plurality of wedges spaced circumferentially about the body. In some embodiments, the method 300 includes aligning the blind flange on the pipe flange using a plurality of alignment pegs (e.g., alignment pegs 150 shown in FIG. 2) protruding from a plate of the blind flange and arranged to fit into mount openings (e.g., mount openings 152 shown in FIG. 2) in the pipe flange.

The method 300 further includes moving 308 the first portion of the clamp body towards the second portion of the clamp body by selectively adjusting a latch (e.g., latch 158 shown in FIG. 2) such that a plurality of wedges (e.g., wedges 156 shown in FIG. 2) of the clamp engage respective outer surfaces of the blind flange and pipe flange to press the blind flange against the pipe flange. The latch may include a threaded rod (e.g., threaded rod 166 shown in FIG. 4) that is engaged with a receiver (e.g., receiver 168 shown in FIG. 4) and threadably engaged with a nut (e.g., nut 170) to secure the clamp on the pipe flange and the blind flange.

The method 300 also includes raising 310 a pressure within the interior space of the pipe using the pressurization device. For example, the pressurization device may deliver pressurized fluid to the interior space to provide a desired pressure within the interior space and monitor the pressure within the interior space to detect any leaks from the pipe.

The technical effects of the systems, apparatus, and methods described herein include: (a) reducing time required to seal a pipe flange; (b) providing an apparatus that allows a pipe flange to be quickly sealed without extensive training or instructions; (c) reducing the likelihood that a pipe flange will be improperly sealed for a hydrostatic pressure test; and (d) providing a method for more efficiently performing a hydrostatic pressure test.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal language of the claims.

What is claimed:

1. An apparatus comprising:
a blind flange configured for sealing engagement with a pipe flange; and
a clamp configured to clamp the blind flange to the pipe flange in sealing engagement, the clamp comprising:
a body configured to extend around the blind flange and the pipe flange, the body comprising a first portion and a second portion movable with respect to the first portion;
a latch configured to secure the body on the blind flange and the pipe flange; and
a plurality of wedges spaced circumferentially about the body and rotatably connected thereto, wherein the latch is selectively adjustable to move the first portion of the clamp body towards the second portion of the clamp body such that the plurality of wedges engage respective outer surfaces of the blind flange and the pipe flange to press the blind flange against the pipe flange.

2. An apparatus in accordance with claim 1, wherein the blind flange comprises a seal that sealingly engages the pipe flange when the blind flange is pressed against the pipe flange.

3. An apparatus in accordance with claim 1, wherein the blind flange comprises a plurality of alignment pegs protruding from a sealing surface of the blind flange, wherein the alignment pegs are sized and shaped to fit into mounting openings defined in the pipe flange.

4. An apparatus in accordance with claim 1, wherein the body of the clamp defines a first ring and a second ring, and wherein each of the plurality of wedges is coupled to and extends between the first ring and the second ring.

5. An apparatus in accordance with claim 1, wherein each wedge of the plurality of wedges includes a first end, a second end, a first side, a second side, a first ramp, and a second ramp opposite the first ramp, wherein the first ramp is configured to engage one of the blind flange and the pipe flange when the clamp is secured around the blind flange and the pipe flange, and wherein the second ramp is configured to engage the other of the blind flange and the pipe flange when the clamp is secured around the blind flange and the pipe flange.

6. An apparatus in accordance with claim 1, wherein the first portion of the clamp body is pivotably connected to the second portion of the clamp body by a hinge, wherein the body is configurable between an open position and a closed position by selectively moving the first portion with respect to the second portion, and wherein the body is configured to encircle the blind flange and the pipe flange in the closed position.

7. An apparatus in accordance with claim 6, wherein the latch is configured to connect the first portion to the second portion and lock the first portion and the second portion in the closed position.

8. An apparatus in accordance with claim 7, wherein the latch comprises a threaded rod, a nut, and a receiver, the threaded rod rotatably connected to one of the first portion and the second portion, the receiver attached to the other of the first portion and the second portion, wherein the latch is configured to tighten the clamp about the blind flange and the pipe flange when the threaded rod is engaged with the receiver and the nut is tightened on the threaded rod.

9. An apparatus in accordance with claim 6, wherein the first portion includes a first plate and a second plate, and wherein the second portion includes a first plate and a second plate, wherein the first plate of the first portion and the first plate of the second portion cooperatively define a first ring when the body is in the closed position, and wherein the second plate of the first portion and the second plate of the second portion cooperatively define a second ring when the body is in the closed position.

10. An apparatus in accordance with claim 9, wherein each of the plurality of wedges is coupled to and extends between the first ring and the second ring.

11. An apparatus in accordance with claim 1, wherein the clamp includes at least one wedge alignment feature associated with each of the plurality of wedges, wherein each of the at least one wedge alignment features limits rotation of the associated wedge such that each of the plurality of wedges faces radially inward when the clamp is secured around the blind flange.

12. An apparatus in accordance with claim 1, wherein the blind flange comprises a solid metal plate.

13. An apparatus in accordance with claim 1, wherein each wedge of the plurality of wedges includes a plurality of ramps facing radially inward to engage the respective outer surfaces of the blind flange and the pipe flange when the clamp is secured around the blind flange and the pipe flange.

14. A system comprising:
a pressurization device connected in fluid communication with an interior space of a pipe and configured to pressurize an interior space of a pipe; and
an apparatus comprising:
a blind flange configured for sealing engagement with a pipe flange of the pipe; and
a clamp configured to clamp the blind flange to the pipe flange in sealing engagement, the clamp comprising:
a body configured to extend around the blind flange and the pipe flange, the body comprising a first portion and a second portion movable with respect to the first portion;
a latch configured to secure the body on the blind flange and the pipe flange; and
a plurality of wedges spaced circumferentially about the body and rotatably connected thereto, wherein the latch is selectively adjustable to move the first portion of the clamp body towards the second portion of the clamp body such that the plurality of wedges engage respective outer surfaces of the blind flange and pipe flange to press the blind flange against the pipe flange.

15. A system in accordance with claim 14, wherein the first portion of the clamp body is pivotably connected to the second portion by a hinge, wherein the body is configurable between an open position and a closed position by selectively moving the first portion with respect to the second portion, and wherein the body is configured to encircle the blind flange and the pipe flange in the closed position.

16. A system in accordance with claim 15, wherein the latch is configured to connect the first portion to the second portion and lock the first portion and the second portion in the closed position, and wherein the latch is configured to tighten the clamp on the blind flange and the pipe flange.

17. A method for hydrostatic pressure testing of a pipe, the method comprising:
connecting a pressurization device in fluid communication with an interior space of the pipe;
positioning a blind flange for sealing engagement with a pipe flange of the pipe;
positioning a body of a clamp around the blind flange and the pipe flange, wherein the body includes a first portion and a second portion movable with respect to the first portion, and wherein the clamp includes a latch and a plurality of wedges spaced circumferentially about the body and rotatably connected thereto;
moving the first portion of the clamp body towards the second portion of the clamp body by selectively adjusting the latch such that the plurality of wedges engage respective outer surfaces of the blind flange and pipe flange to press the blind flange against the pipe flange; and
raising a pressure within the interior space of the pipe using the pressurization device.

18. A method in accordance with claim 17, wherein the first portion of the clamp body is pivotably connected to the second portion of the clamp body by a hinge, wherein positioning a body of a clamp around the blind flange and the pipe flange comprises rotating the first portion of the clamp body relative to the second portion of the clamp body such that the clamp body encircles the blind flange and the pipe flange.

19. A method in accordance with claim 17, wherein the latch includes a threaded rod, a receiver, and a nut, wherein tightening the clamp to press the blind flange against the pipe flange comprises tightening the clamp on the pipe flange and the blind flange by tightening the nut on the threaded rod engaged with the receiver.

20. A method in accordance with claim 17 further comprising aligning the blind flange on the pipe flange using a plurality of alignment pegs protruding from a sealing surface of the blind flange, wherein the plurality of alignment pegs are shaped and sized to fit into mount openings in the pipe flange.
